(19) United States
(12) Patent Application Publication
(10) Pub. No.: US 2008/0226114 A1
(43) Pub. Date: Sep. 18, 2008

(54) Earbud Adapter with Enhanced Frequency Response

(75) Inventors: Steven Thompson, Burnsville, MN (US); Michael T. Venem, Saint Paul, MN (US); Martin P. Babcock, White Bear Lake, MN (US); William Parish, Maplewood, MN (US); Robert J. Oliveira, Maplewood, MN (US)

Correspondence Address: CROMPTON, SEAGER & TUFTE, LLC, 1221 NICOLLET AVENUE, SUITE 800, MINNEAPOLIS, MN, 55403-2420, US

(73) Assignee: HEARING COMPONENTS, INC., Oakdale, MN (US)

(21) Appl. No.: 11/686,849

(22) Filed: Mar. 15, 2007

(51) Int. Cl. H04R 25/00

(52) U.S. Cl. 381/380

(57) ABSTRACT

Adapters for use with sound devices and methods for making and using the same. An adapter may include an adapter body including a wall having a first surface and a second surface, and a projection extending from the wall. The adapter is generally configured to be attachable to a sound device such as an earbud or earphone. A sleeve configured to at least in part extend into the ear canal of a user during use may be attached to the projection. The adapter may additionally include one or more unobstructed orifices extending through the wall of the adapter between the first surface and the second surface. The one or more unobstructed orifices may allow leakage of acoustical energy from the adapter, thus modifying the level of sound energy at certain frequencies transmitted to the ear canal of a user.

### CROSS REFERENCE TO RELATED APPLICATIONS

The present application is related to co-pending application Ser. No. 10/753,591 entitled “Earbud Adapter” filed on Jan. 7, 2004, which is incorporated herein in its entirety.

### TECHNICAL FIELD

The present disclosure pertains to sound devices and adapters or devices for use with sound devices. More particularly, the present invention pertains to adapters for use with earbud-type headphones that improve the comfort of the headphones, isolate the ear from extraneous sounds, modify frequency response, and/or modify levels of sound energy at certain frequencies experienced by a user.

### BACKGROUND

Sound devices such as headphones are used extensively throughout the world. One style of headphones that is commonly used is referred to as an earbud or an earbud-type headphone. Earbuds (i.e. earphones) are small speaker-like devices that are designed to fit within the external ear of a listener so that the user can listen to sound being transmitted from a sound source. Some examples of typical sound sources where earbuds may be used include personal and/or portable audio players (including radios, cassette players, compact disc players, portable mp3 players, etc.), portable DVD players, telephones (including wireless and cellular-type telephones), etc. When properly positioned in the ear, earbuds can provide the listener with acceptable sound transmission to the ear canal. However, due to person-to-person variations and variations in the environment in which the earbuds are used, fit may not be adequate and extraneous noise may make transmission inadequate.

A wide variety of headphones and earbuds (i.e. earphones) have been developed as well as a number of adapters and prostheses attachable to these devices. In addition, a wide variety of methods for manufacturing headphones (including earbuds) and adapters have been developed. Among these known devices and methods, each has certain advantages and disadvantages.

Adapters for use wit earbuds, as well as earbud devices with integral sound tubes, are intended to channel sound transmitted from the driver (e.g., speaker) of the sound device into the ear canal of a user. Although such devices perform well for transmitting sound into the ear canal of a user, in some instances it has been found that the level of sound energy at certain wavelengths transmitted into the ear canal of a user may be undesirable for some users. For example high levels of low frequency sound (i.e., bass) transmitted into the ear canal of a user have been found to be undesirable by some users.

There is an ongoing need to provide alternative devices and methods for making these devices which improve sound transmission, while providing the desired frequency response desired by a user.

### BRIEF SUMMARY

The present disclosure relates to sound devices and adapters and/or prostheses for use with sound devices.

One example embodiment is an adapter which may include an adapter body having a first side, a port or projection extending from the first side, and a second side. The adapter is generally configured to be releasably attachable to an earbud or earbud-type headphone with the second side facing the earbud, which would be positioned in the outer ear during use. A sound conduit extends through the projection and is configured to direct sound energy to the ear canal of a user. The projection may include a sleeve attached thereto. The projection in one embodiment or the projection and sleeve in an alternative embodiment are generally configured to extend into the ear canal of a user. In preferred embodiments, a sleeve or foam cover is positioned over the projection to provide a contact surface which generally conforms to the user's ear canal shape when at least a portion of the sleeve is positioned therein. The adapter may additionally include at least one unobstructed orifice or leak opening extending through the adapter body from the first side to the second side. The at least one unobstructed orifice allows for the leakage of acoustical energy from the adapter, thereby modifying the frequency response of the adapter 10, such as reducing or altering the level of low frequency acoustic energy traveling through the sound conduit of the adapter. Some of these and other features are described in more detail below.

Another example embodiment is an earbud-type sound device including a housing and a driver located within the housing, providing acoustical energy from an acoustical output side of the driver. The earbud further includes a grille positioned in front of the driver on the acoustical output side of the driver and a dome-shaped cover positioned in front of the grille. The dome-shaped cover has an inner surface, for example a concave surface, spaced away from the grille, thereby defining a sound transmitting cavity between the inner surface of the cover and the grille. A projection including a sound conduit for delivering sound to an ear canal of a user extends from the cover. A sleeve may be disposed over at least a portion of the projection. The cover may additionally include an unobstructed orifice on the acoustical output side of the driver. The unobstructed orifice has a perimeter, wherein at least a portion of the perimeter of the unobstructed orifice is spaced from the grille. In some embodiments the unobstructed orifice and the sound conduit may open into the sound transmitting cavity.

The above summary of some example embodiments is not intended to describe each disclosed embodiment or every implementation of the invention.

### BRIEF DESCRIPTION OF THE DRAWINGS

FIG. 1 is a perspective view of an example adapter;

FIG. 2 is an alternative perspective view of the example adapter depicted in FIG. 1;

FIG. 3 is a side view of an example sleeve for use with an adapter;

FIG. 4 is a cross-sectional view of the sleeve depicted in FIG. 3;

FIG. 5 is an exploded view of an example sound device, adapter, and sleeve;

FIG. 6 is a perspective view showing the connection of the sound device, adapter, and sleeve;

FIG. 7 is a cross-sectional view of an example coupling member;

FIG. 8 is a cross-sectional view of the coupling member of FIG. 7 attached to a sleeve;

FIG. 9 is a cross-sectional view of another example coupling member;

FIG. 10 is a cross-sectional view of the coupling member of FIG. 9 attached to a sleeve;

FIG. 11 is an exploded view of another example adapter body, coupling member, and sleeve;

FIG. 12 is an exploded view of still another example adapter body, coupling member, and sleeve;

FIG. 13 is an exploded view of still another example adapter body, coupling member, and sleeve;

FIG. 14 is a perspective view of another example sleeve;

FIGS. 15A-15K are various arrangements of one or more unobstructed orifices of an adapter;

FIGS. 16A and 16B are graphs depicting the frequency response of several adapter configurations;

FIGS. 17A and 17B are cross-sectional views of an exemplary adapter in association with an earbud;

FIGS. 18A-18C are plan views of an exemplary adapter having means for regulating the unobstructed area of one or more orifices of an adapter;

FIGS. 19A-19C are plan view of another exemplary adapter having means for regulating the unobstructed area of one or more orifices of an adapter;

FIG. 20A is a perspective view of another exemplary adapter;

FIG. 20B is a cross sectional view of the adapter of FIG. 20A taken along line 20B-20B of FIG. 20A;

FIG. 20C is a cross sectional view of the adapter of FIG. 20A taken along line 20C-20C of FIG. 20A;

FIG. 21A is a perspective view of an earbud with an integral cover;

FIG. 21B is a cross sectional view of the earbud with an integral cover shown in FIG. 21A; and

FIG. 22 is a plan view of yet another exemplary adapter.

### DETAILED DESCRIPTION

The following description should be read with reference to the drawings wherein like reference numerals indicate like elements throughout the several views. The detailed description and drawings illustrate example embodiments of the claimed invention.

All numeric values are herein assumed to be modified by the term “about”, whether or not explicitly indicated. The term “about” generally refers to a range of numbers that one of skill in the art would consider equivalent to the recited value (i.e., having the same function or result). In many instances, the term “about” may be indicative as including numbers that are rounded to the nearest significant figure.

The recitation of numerical ranges by endpoints includes all numbers within that range (e.g., 1 to 5 includes 1, 1.5, 2, 2.75, 3, 3.80, 4, and 5).

Although some suitable dimensions, ranges and/or values pertaining to various components, features and/or specifications are disclosed, one of skill in the art, incited by the present disclosure, would understand desired dimensions, ranges and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The following detailed description should be read with reference to the drawings in which similar elements in different drawings are numbered the same. The detailed description and the drawings, which are not necessarily to scale, depict illustrative embodiments and are not intended to limit the scope of the invention. The illustrative embodiments depicted are intended only as exemplary. Selected features of any illustrative embodiment may be incorporated into an additional embodiment unless clearly stated to the contrary.

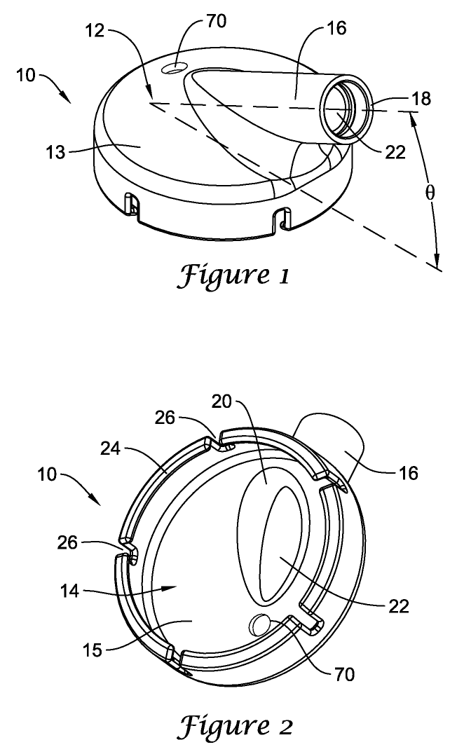

FIGS. 1 and 2 are perspective views of an example adapter body 10 for use with an earbud or an earbud-type sound device or earphone. Adapter 10 includes a top portion or side 12 including a first surface 13, as best seen in FIG. 1, and an opposing second surface 15, as best seen in FIG. 2, and a bottom portion or side 14 including a coupling portion, as best seen in FIG. 2. A projection or port 16 extends from the first surface 13 of the top portion 12. A port opening 18 is defined in projection 16. In some embodiments, opening 18 is at the distal terminus of projection 16. In other embodiments, opening 18 can be disposed at other locations along projection 16. A second opening 20 is defined in adapter body 10 that is disposed on second surface 15 of top portion 12 within the cavity formed in the adapter body 10. A sound conduit 22 is defined in adapter body 10 that extends through projection 16 between first opening 20 and second opening 18. Sound conduit 22 generally allows sound (acoustical energy) to pass from a driver (e.g., a speaker) of a sound device (to which adapter body 10 is attached), into and through opening 20, through projection 16, through and out from opening 18, and into the ear canal of a user. Thus, sound conduit 22 directs acoustical energy output from the driver of a sound device into the ear canal of a user.

Adapter body 10 is configured to be attachable to an earbud or earbud-type sound device. An earbud or earbud-type device, otherwise known as an earphone, is one that normally rests within the outer ear during use. Preferably, adapter body 10 is configured for being detachably connectable to a sound device. When describing the adapter body 10 as being detachably connectable or removably coupled to an earbud, what is meant is that the adapter body 10 may be selectively removed from the earbud throughout normal usage of the device without causing unintended damage or harm to either the adapter 10 or the earbud. The adapter 10 may include a coupling portion for coupling the adapter 10 to a housing of a sound device. This feature allows a user to freely attach and detach adapter body 10 as desired. However, the adapter body 10 is held in place with sufficient force to retain its position on the sound device during use. The adapter 10 may be exchanged for another adapter as desired in instances where the sound device is used by multiple users and/or in different environments. In addition, the user may discard adapter body 10 after use, if desired, and replace it with a new one for subsequent uses. The earbud or earbud-type sound device may be a part of a cell phone headset, CD player or any other sound transmission device. It may include one or more ear buds.

The materials used to manufacture adapter body 10 may vary. In some embodiments, adapter body 10 is made from a polymer. Because a number of polymers are relatively inexpensive, constructing adapter body 10 from a polymer may desirably impact the manufacturing costs. In addition, because of the relatively low manufacturing costs that are contemplated, adapter body 10 may be inexpensive for the consumer and disposable. Some examples of suitable polymers may include ethylene tetrafluoroethylene (ETFE), fluorinated ethylene propylene (FEP), polyoxymethylene (POM), polybutylene terephthalate (PBT), polyether block ester, polyurethane, polypropylene (PP), polyvinylchloride (PVC), polyether-ester (for example, a polyether-ester elastomer such as ARNITEL® available from DSM Engineering Plastics), polyester (for example a polyester elastomer such as HYTREL® available from DuPont), polyamide (for example, DURETHAN® available from Bayer or CRISTAMID® available from Elf Atochem), elastomeric polyamides, block polyamide/ethers, polyether block amide (PEBA, for example, available under the trade name PEBAX®), silicones, polyethylene (PE), Marlex high-density polyethylene, Marlex low-density polyethylene, linear low density polyethylene (for example, REXELL®), polyethylene terephthalate (PET), polyetheretherketone (PEEK), polyimide (PI), polyetherimide (PEI), polyphenylene sulfide (PPS), polyphenylene oxide (PPO), polysulfone, nylon, perfluoro(propyl vinyl ether) (PFA), other suitable materials, or mixtures, combinations, copolymers thereof, polymer/metal composites, and the like.

As suggested above, bottom portion 14 is configured so that adapter body 10 can releasably attach to a sound device. In some embodiments, bottom portion 14 can include coupling portion, such as a ridge or rim 24 that is adapted to fit over and generally be disposed along the perimeter of the earbud or earbud-type sound transmitting device. It can be seen in FIG. 2 that rim 24 may be generally circular in shape so as to correspond to the generally circular and/or conical shape of the housing of a sound device. However, other shapes are contemplated, depending on the shape of the sound device. For example, rim 24 could be oval, squared, polygonal, etc. so as to improve the compatibility, attachability, and detachability of adapter body 10 to a variety of sound devices. In addition, one or more notches 26 may be defined in rim 24, which can allow rim 24 to adjust to somewhat differently sized or shaped sound devices and allow adapter body 10 to more easily attach and detach from the sound device while providing a sufficient interference fit, such as frictional or interlocking engagement. This feature may allow a consumer to use one particular adapter body 10 embodiment with a number of differently sized or shaped sound devices. In some embodiments the material selected for adapter body 10 may be sufficiently elastic such that the adapter body may be stretched over the housing of a sound device and retained thereon.

In some embodiments, projection or port 16 is generally configured for extending into the ear canal of a user during use. In order for projection 16 to be properly positioned and/or seated in the ear canal, projection 16 preferably extends at a selected angle θ from the first surface 13 of the top portion 12, as shown in phantom in FIG. 1. In some embodiments, the angle θ may be an angle other than 90°, for example, in some embodiments the angle θ may be an acute angle measured between the longitudinal axis of the projection 16 and a plane defined across the open side of the bottom portion 14 of the adapter body 10. By being disposed at a selected acute angle, the design of adapter body 10 allows top portion 12 to rest in the outer ear while still allowing projection 16 to extend into the external auditory meatus (i.e., the auditory or ear canal). In one preferred embodiment, the angle θ is between about 0 degrees to about 45 degrees. In another preferred embodiment, projection 16 is disposed at an angle of about 15±10 degrees. However, in other embodiments the angle θ may vary depending on the anatomy of a user's ear. These ranges assume that adapter body 10 is positioned in the ear in a manner so that the contours of top portion 12 are substantially parallel to the contours of the concha (i.e., the bowl of the ear). It can be appreciated that angle θ can vary outside these ranges, particularly if adapter body 10 is positioned in the ear in a manner so that top portion 12 is not substantially parallel to the concha. For example, if the adapter body 10 is disposed at another position in the car, partially or completely behind the ear, or at some other location, a number of differing angles θ are contemplated. For example, in some embodiments the angle θ may be between about 45 degrees and 75 degrees. In addition, the material composition and design of adapter body 10 may allow angle θ to be variable for any particular adapter body 10. For example, adapter body 10 may be configured so that angle θ can bend or flex so that adapter body 10 can fit more comfortably in a variety of different users' ears. According to this embodiment, angle θ may vary within any given adapter body 10.

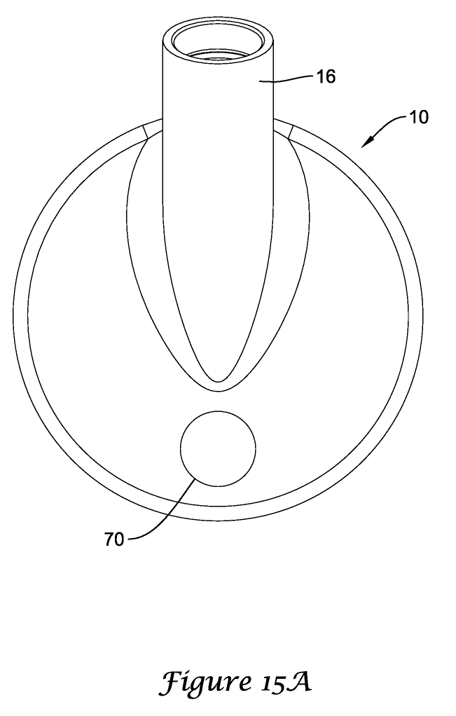

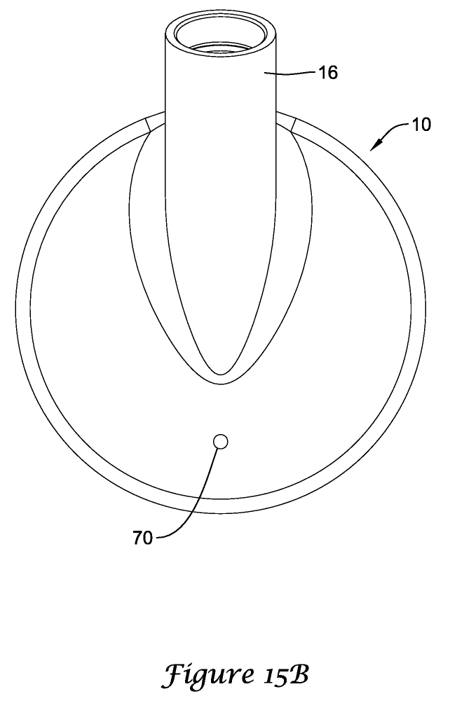

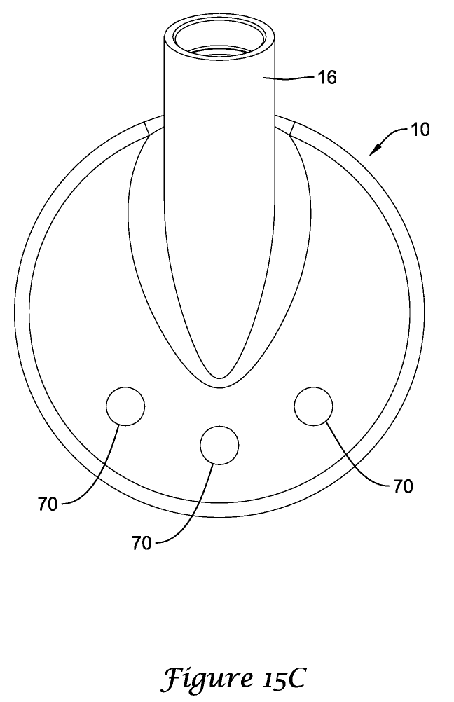

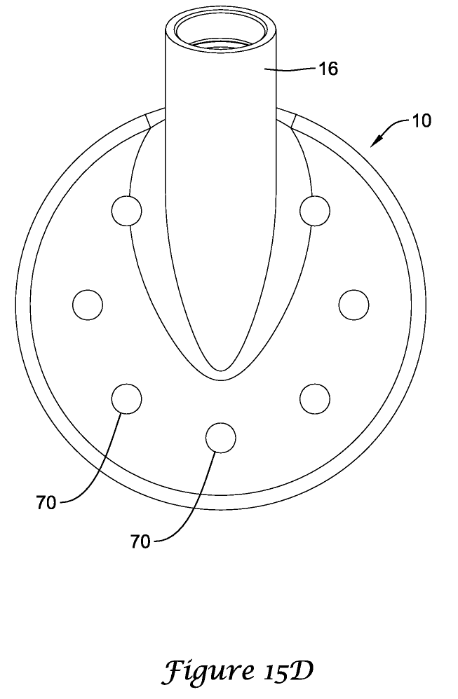

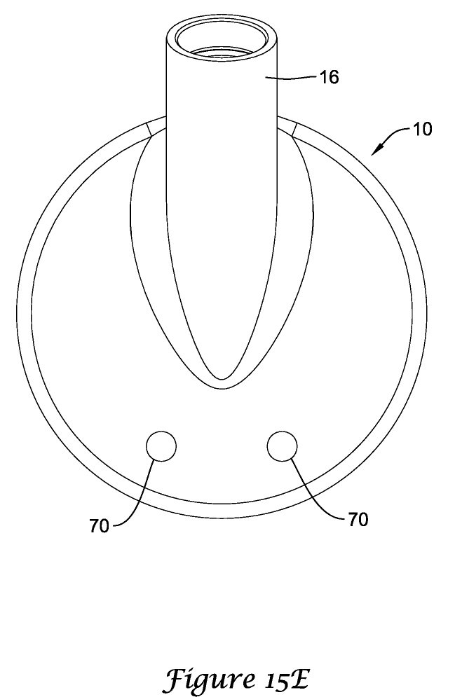

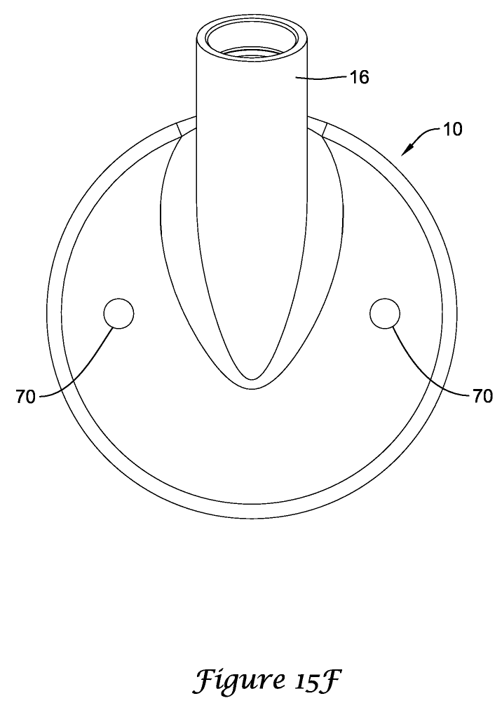

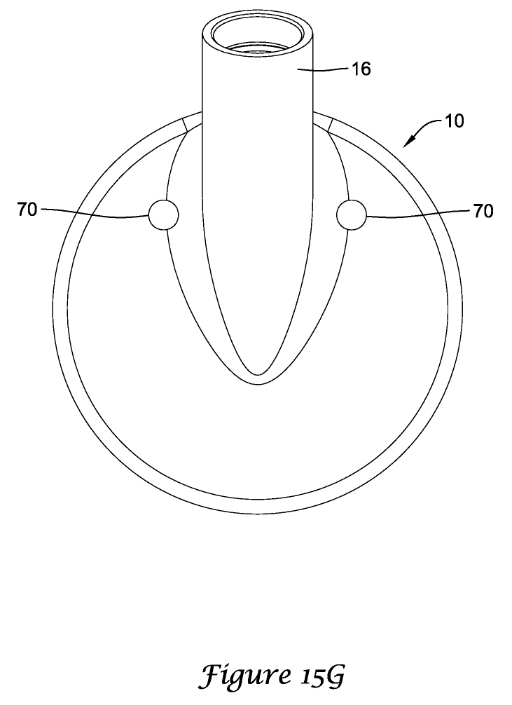

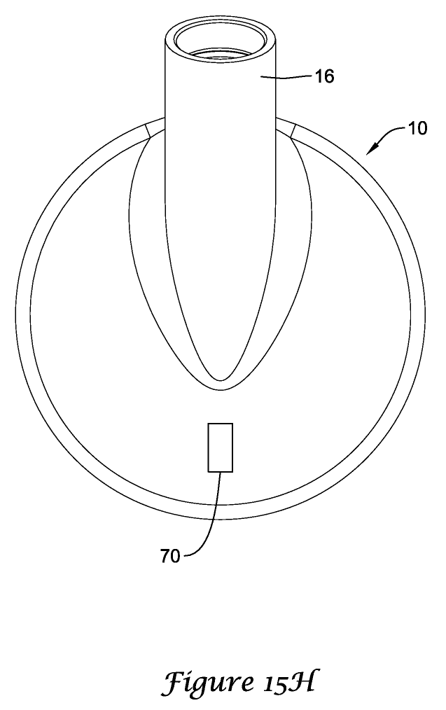

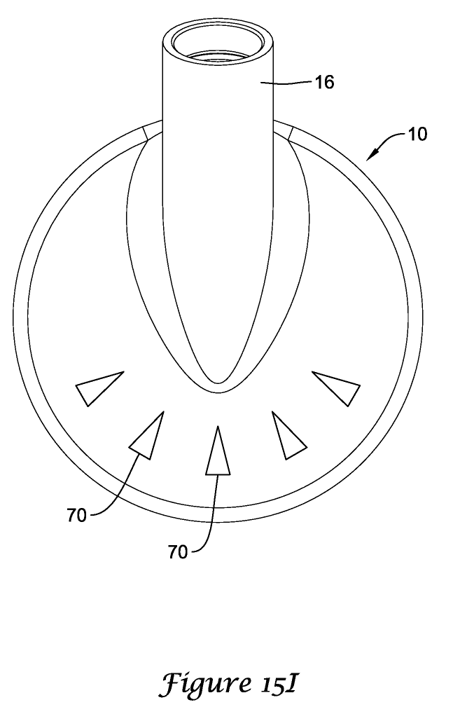

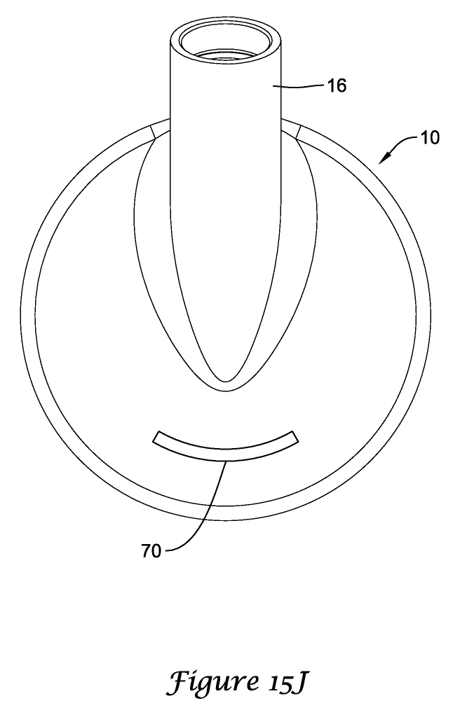

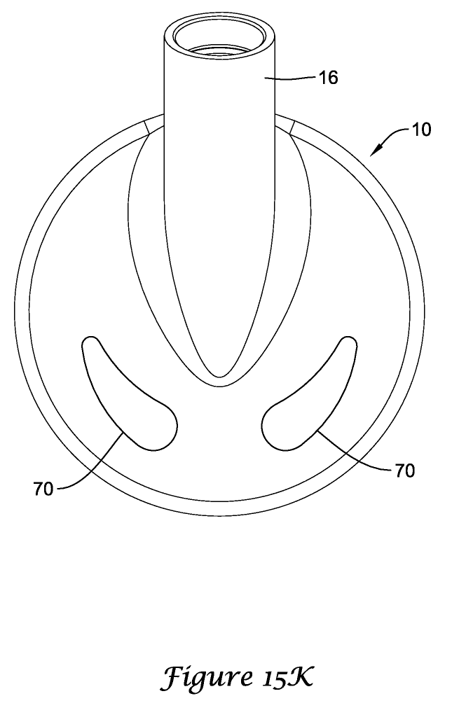

As shown in FIGS. 1 and 2, the adapter body 10 may also include one or more openings or orifices 70 extending through the adapter body 10 from the first surface 13 to the second surface 15. Although a single opening or orifice 70 is illustrated in FIGS. 1 and 2, in other embodiments the adapter body may include two, three, four, five, six, seven, eight or more openings or orifices as desired. As shown in FIG. 1, the opening or orifice 70 is an opening other than those associated with the sound conduit 22. The one or more openings or orifices 70 are at least in part unobstructed. In describing the one or more openings or orifices 70 as unobstructed openings 70, what is intended is that the one or more openings or orifices 70 are one or more through holes extending through the wall of the adapter 10, or that portion of one or more through holes extending through the wall of the adapter which are not blocked, covered or otherwise obstructed by another component or substance, and which allow sound energy to pass therethrough. Thus, the one or more unobstructed openings or orifices 70 is/are open to the leakage of acoustical energy therethrough in order to enhance the frequency response of the adapter 10. When adapter 10 is coupled to an earbud sound device, the one or more openings or orifices 70 may be located on the output side of a driver of an earbud. As discussed later herein, the one or more openings or orifices 70 may allow leakage of acoustical energy from the adapter 10. Thus, the one or more openings or orifices 70 may modify or alter the level of sound energy transmitted through the sound conduit 22 to the ear canal of a user. For example, in some embodiments the one or more openings or orifices 70 may reduce or alter the level of sound energy transmitted through the sound conduit 22 to the ear canal of a user. Some examples of various configurations, shapes, and sizes of the one or more openings or orifices 70 are illustrated in FIGS. 15A-15K. However, these are only illustrative as other configurations, shapes and sizes are contemplated.

As shown in FIGS. 15A and 15B the adapter 10 may include a single unobstructed orifice 70 extending through the adapter body 10. The orifice 70 is illustrated as a circular orifice in each of FIGS. 15A and 15B. However, other shapes are contemplated. The orifice 70 of the adapter 10 shown in FIG. 15A is larger than the orifice 70 of the adapter 10 shown in FIG. 15B. For example, in some embodiments the hole 70 may have a diameter of about 0.02 inches, about 0.025 inches, about 0.05 inches, about 0.075 inches, about 0.1 inches, 0.2 inches, 0.3 inches, or about 0.5 inches. In some embodiments the distance across the orifice 70 (e.g., the diameter in the case of a circular opening) may be in the range of about 0.02 inches, about 0.025 inches to about 0.5 inches, or in the range of about 0.025 inches to about 0.2 inches, or in the range of about 0.05 inches to about 0.1 inches, or in the range of about 0.1 inches to about 0.3 inches, for example. In some embodiments the orifice 70 may have an area of between about 0.0003 in² to about 0.07 in², between about 0.0005 in² to about 0.07 in², between about 0.0005 in² to about 0.005 in², between about 0.005 in² to about 0.02 in², or about 0.02 in² to about 0.07 in². As discussed herein, the size (i.e., the area) of the orifice 70 may modify or alter the frequency response in certain frequency ranges. For example, in some embodiments the size of the orifice 70 may dictate the level of acoustic energy reduction or modification in certain frequency ranges experienced by a user using the adapter 10 with an earbud sound device.

FIGS. 15C-15G illustrate various embodiments of an adapter 10 having a plurality of orifices 70. As shown in the figures, an adapter 10 may have two, three, four, five, six, seven, eight, or more orifices 70, as desired. The orifices 70 may be circular, polygonal (e.g., triangular, rectangular, square, etc.), oval, teardrop-shaped, irregular shaped, or any other desired shape. As shown in FIG. 15C the adapter 10 may have an arrangement of three orifices 70, which may be circular openings in some embodiments, although other shapes are contemplated. An adapter 10 having an arcuate array of orifices 70 is illustrated in FIG. 15D. FIGS. 15E-15G illustrate some exemplary locations in which the orifices 70 may be positioned on the adapter 10, thus the location of the one or more orifices 70 is not limited to any certain location of the adapter 10. However, it may be desired to locate the one or more orifices 70 at a location in which the one or more orifices 70 will remain unobstructed by the earbud sound device when coupled to an earbud device, as well as by the anatomy of a user when the adapter 10 is positioned in the ear canal of a user.

FIGS. 15H-15K illustrate various embodiments of an adapter 10 having one or more non-circular orifices 70. As shown in FIG. 15H the orifice 70 may be square or rectangular in some embodiments. FIG. 15I depicts an adapter 10 including a plurality of triangular shaped orifices 70 positioned in an arcuate array. FIG. 15J illustrates an adapter 10 including an elongate orifice 70, for example a slot, extending through the body of the adapter 10. An adapter 10 including a plurality of irregular shaped orifices 70 is illustrated in FIG. 15K.

The total area of the sum of the one or more unobstructed orifices 70 through the adapter body 10 may be in the range of between about 0.0003 in² to about 0.1 in², in some embodiments. For example, in some embodiments the total area of the sum of the one or more orifices 70 may be at least 0.0003 in², at least 0.0005 in², at least 0.001 in², at least 0.002 in², at least 0.005 in², at least 0.008 in², at least 0.01 in², at least 0.02 in², at least 0.025 in², at least 0.03 in², at least 0.05 in², at least 0.07 in², or at least 0.1 in². In some embodiments, the total area of the sum of the one or more unobstructed orifices 70 may be in the range of between about 0.0003 in² to about 0.05 in², between about 0.0005 in² to about 0.005 in², between about 0.005 in to about 0.05 in², between about 0.005 in² to about 0.01 in², or between about 0.01 in² to about 0.03 in², for example.

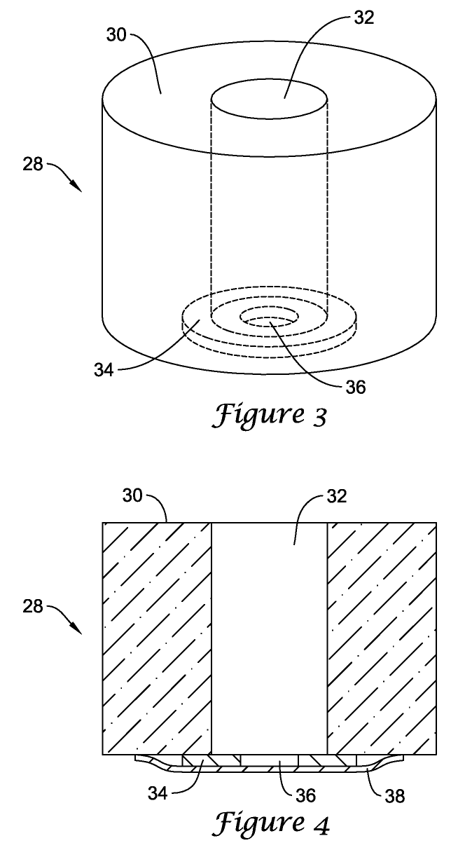

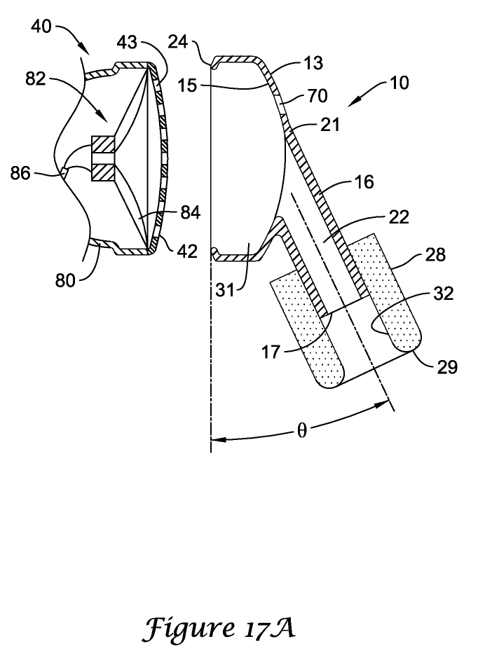

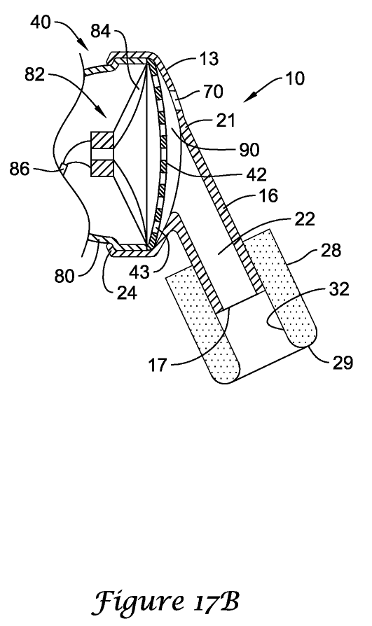

In preferred embodiments, a sleeve or foam cover 28 may be coupled to projection 16. Sleeve 28 may be coupled to projection 16 in any number of suitable manners such as with an adhesive. As shown in FIGS. 17A and 17B, sleeve 28 is fixedly attached to projection 16. Alternatively, sleeve 28 may be attached using a coupling member as described in more detail below. A side view of an example sleeve 28 is depicted in FIG. 3, and a cross-sectional view of sleeve 28 is shown in FIG. 4. In these figures, it can be seen that sleeve 28 may be generally cylindrical in shape, however, other shapes are contemplated. Additionally, sleeve 28 may include a first surface 30 and an axial lumen 32 in first surface 30 that extends into sleeve 28. In some embodiments, lumen 32 extends into only a portion of sleeve 28. In other embodiments, lumen 32 extends all the way through sleeve 28. Some of the features and characteristics of a suitable sleeve 28 can be found in U.S. Pat. No. 5,920,636, the disclosure of which is incorporated herein by reference.

Sleeve 28 may also include a number of other structural components. For example, a lock ring 34 may be disposed at one end of sleeve 28 and attached to sleeve 28 by any suitable means. The mechanism for attaching lock ring 34 to sleeve 28 may vary. For example, lock ring 34 may be mechanically attached, adhesively bonded, thermally bonded, and the like, or otherwise attached in any suitable manner. Lock ring 34 may include a hole 36 that may be axially aligned with lumen 32. In some embodiments, lock ring 34 partially covers hole 36 so that hole 36 of lock ring 34 is smaller than axial lumen 32 of sleeve 28. In other embodiments, hole 36 is about the same size or slightly larger than axial lumen 32. Lock ring 34 may be made from a stiffer, yet deformable material such as a stiffer foam, polyethylene, polyurethane, polyethylene terephthalate, or any other suitable material including those disclosed herein. The use of lock ring 34, and variants thereof, is described in more detail below. Sleeve 28 may also include a thin layer 38 of a sound-transmitting material or scrim (e.g., preferably a reticulated open cell foam or partially open cell foam) that helps prevent detritus or cerumen from the ear canal from entering a sound delivery tube of a sound device on which sleeve 28 may be mounted.

Sleeve 28 can be of many different types of materials such as a polymer or foam. Some example polymers are listed above. A number of different types of foams exist, which may be suitable for some embodiments. For example, sleeve 28 could be made of a sound attenuating slow recovery foam. This type of foam may allow the user to compress sleeve 28 with his/her fingers before it is placed in the ear canal, after which it recovers its shape sufficiently so that its periphery conforms to the inner surface of the ear canal. This feature can improve the fit and comfort of adapter body 10 (and sleeve 28) in the ear canal. In addition, this type of foam can substantially block sounds from entering the ear canal other than sounds transmitted from the sound device that pass through adapter body 10. This feature may be desirable because blocking extraneous sound “isolates” the ear in which sleeve 28 is disposed from these other sounds.

It is believed that isolating an ear from other sounds (i.e., sounds not originating from the sound device) allows the user to better process sound coming from the sound device, even when the device is only in one ear with the other ear receiving the extraneous sounds. This allows the user to better distinguish the sounds from the sound device from other sounds that could be distracting. This feature may be particularly useful when the sound device is an earbud connected to a telephone because the user would be able to adequately hear and distinguish voices from the telephone from other sounds or voices that might be present in the area. This feature also reduces the likelihood that sounds originating from the sound device would be confused with extraneous sounds, even when the user's other ear does not have any sound device disposed therein. Moreover, by reducing the amount of unwanted sound that enters the ear, a lesser degree of energy can be delivered to the eardrum for the same level of sound perception and intelligibility. This can protect the eardrum from damage that could be caused by exposure to greater amounts of energy or otherwise help preserve or enhance the long-term health of the ear.

Where it is desirable to have sounds enter the ear both through the sound device and sleeve 28, sleeve 28 can be of a more sound transmissive foam such as open cell foam or a reticulated open cell foam selected for the amount of sound transmission desired. Typically, such open cell foams are sufficiently compressible so that the periphery will conform to the inner surface of the ear canal as sleeve 28 is pushed into it. It can be appreciated that the use of a number of other types of foams and similar materials are contemplated. For example, in some embodiments partially open cell foams may be used. In addition, a plethora of other suitable materials are contemplated, including silicone rubber and elastomeric polymers.

The following examples of dimensions for sleeve 28 are provided for illustrative purposes and are not intended to be limiting. In some embodiments, sleeve 28 can have a diameter of about 0.35 to about 0.65 inches and an axial length between its surfaces of about 0.15 to about 0.65 inches. Lumen 32 may have a diameter of about 0.08 to about 0.19 inches. Lock ring 34 can be of a polymeric material about 0.005 to about 0.025 inches in thickness. Lock ring 34 can have an outer diameter of about 0.15 to about 0.30 inches. Hole 36 in lock ring 34 may have a diameter of about 0.05 to about 0.15 inches. The diameter of hole 36 can provide for a clearance fit of about 0.005±0.003 inches to an interference fit of about 0.020±0.010 inches between the lock ring 34 and the bottom of a grooved coupling (e.g., a groove defined in projection 16 or in a coupling member such as the one described below), that fit being selected to provide the degree of engagement desired between sleeve 28 and adapter body 10. Such interference fits may cause a portion of lock ring 34 to remain in a slightly frusta-conical shape after engagement around projection 16, which insures firm engagement therebetween.

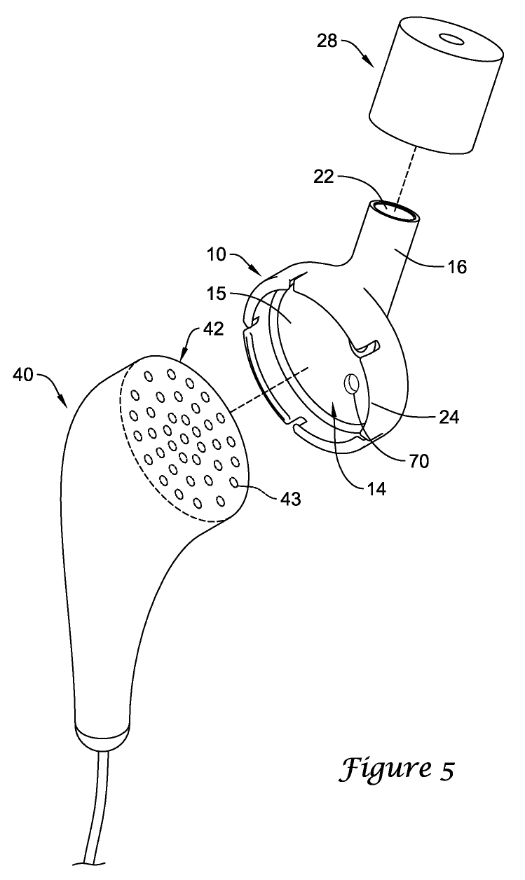

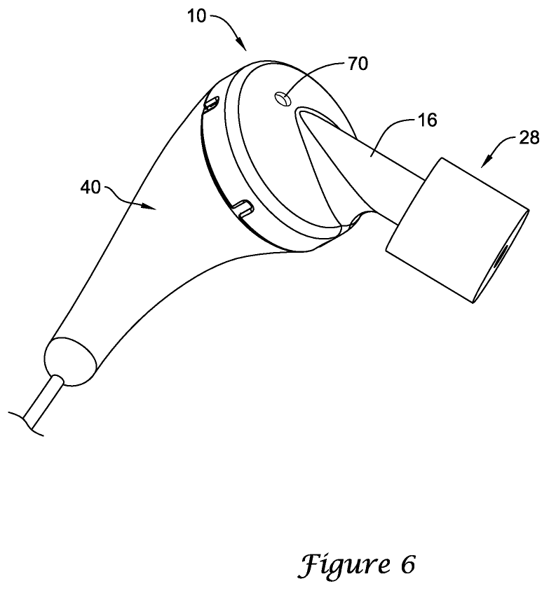

An exploded view of an earbud-type sound device 40 (depicted as an earbud), adapter body 10, and sleeve 28 is depicted in FIG. 5. Here the relationships of the relevant devices can be more clearly seen. For example, rim 24 of adapter body 10 can be disposed over earbud 40 so that speaker grille 42 is seated facing the second surface 15 of top portion 12. Thus, when coupled to an earbud, the adapter body 10 is able to receive the acoustical energy output from the speaker grille 42 through sound emanating from through holes 43 in the speaker grille 42. Sleeve 28 can be disposed over a portion of projection 16. Sound emitted from earbud 40 can pass through sound conduit 22 and, ultimately, into the ear canal of a user. A perspective view of earbud 40, adapter body 10, and sleeve 28 as connected is shown in FIG. 6. The adapter body 10 is rotated to a position which provides the best fit for the particular user when the port 16 extends into the ear canal and the earbud rests in the outer ear. This preferred orientation is generally depicted in FIG. 6.

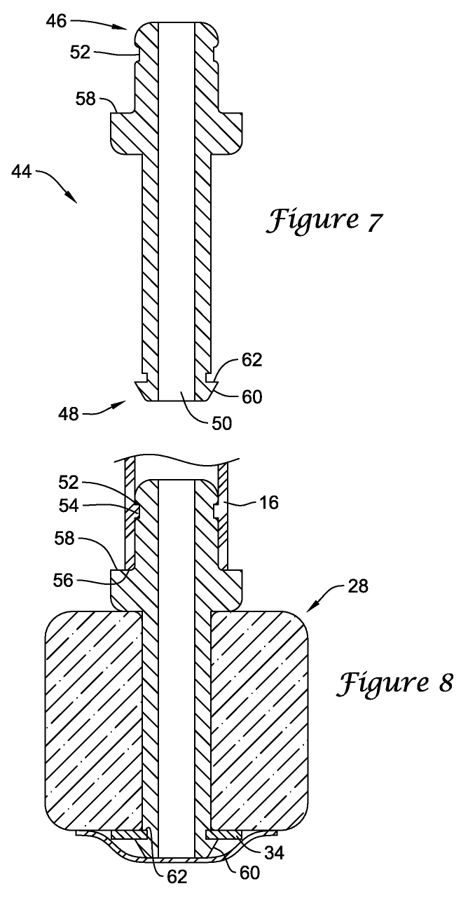

As described above, sleeve 28 may be coupled to projection 16 with an adhesive or any other suitable means. Alternatively, sleeve 28 may be attached to projection 16 with a coupling member 44. A cross-sectional view of an example coupling member 44 is shown in FIG. 7. Coupling member 44 may include a first end region 46, a second end region 48, and a sound channel 50 extending therethrough in communication with sound conduit 22 when positioned on or integrally formed with projection 16. First end region 46 may be configured for being attached to projection 16. For example, a groove or notch 52 may be defined adjacent first end region 46 that is adapted to engage a corresponding protrusion 54 defined in projection 16 as seen in FIG. 8. Groove 52 and protrusion 54 can interlock when first end 46 is disposed into projection 16. Alternatively, first end region 46 may simply be disposed into projection 16 (regardless of whether or not projection 16 includes protrusion 54) and secured with an adhesive, another type of mechanical bond, a friction fit bond, a thermal bond, and the like, or any other suitable way. When coupled, the distal end 56 of projection 16 may be seated against or adjacent a shelf region 58 of coupling member 54.

Second end region 48 is configured to releasably attach to sleeve 28. For example, second end region 48 may include a sloped portion 60 and a notch 62 that is configured to engage lock ring 34. According to this embodiment, second end region 48 can be advanced through lumen 32 of sleeve 28 so that sloped portion 60 comes into contact with lock ring 34. Further advancing second end region 48 results in sloped portion 60 passing through hole 36 in lock ring 34 so that, ultimately, lock ring 34 ”snaps” into position and becomes disposed in notch 62. This can result in a stable interference type mechanical bond between sleeve 28 and coupling member 44.

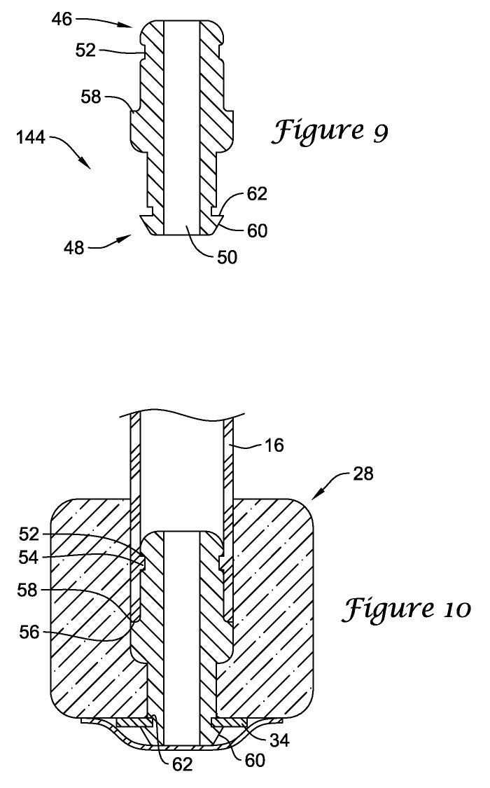

FIG. 9 is a cross-sectional view of another example coupling member 144 that is shorter but otherwise similar to coupling member 44. First end region 46 of coupling 144 may be configured for being attached to projection 16, for example, via engagement of notch 52 with protrusion 54 or by disposing first end region 46 into projection 16 as described above. Because coupling member 144 is shorter than coupling member 44, first end region 46 terminates or is otherwise disposed within sleeve 28 (i.e., within hole 32 of sleeve 28) when it is engaged with lock ring 34. Accordingly, distal end 56 of projection 16 is also disposed within sleeve 28 when projection 16 is engaged with coupling member 144 and sleeve 28 as shown in FIG. 10. The relationships between the other components of coupling member 144 with sleeve 28 may be substantially similar to the relationships described above in regard to coupling member 44.

In some embodiments, coupling member 44 may be “pre-attached” to or “formed integral” with adapter body 10. This feature allows a user to simply attach sleeve 28 to projection 16 as needed and use adapter body 10 and sleeve 28 with the earbud or other sound device. Alternatively, a kit may be provided that includes adapter body 10, coupling member 44, and sleeve 28. According to this embodiment, the user may attach coupling member 44 to projection 16 (e.g., as described above) and attach coupling member 44 to sleeve 28. Either way, adapter body 10 (which may have sleeve 28 attached thereto) can be disposed over the ear bud, and sleeve 28 can be disposed in the ear canal. Alternatively, adapter body 10 can be provided with sleeve 28 permanently attached thereto. As previously stated, this entire assembly would then be disposable by the user.

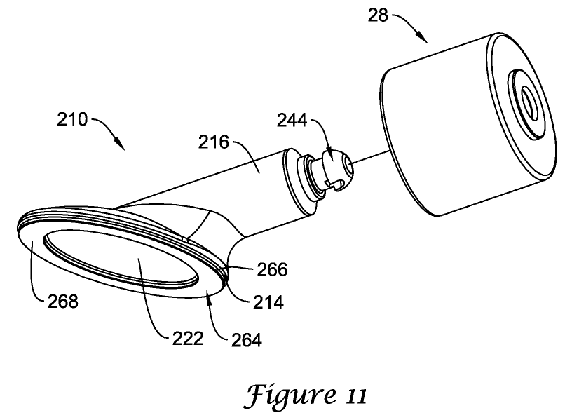

FIG. 11 is an exploded view of another adapter body 210 for use with coupling member 244 (which may be similar to any of the coupling members disclosed herein) and sleeve 28. Adapter body 210 is similar to adapter body 10 except that it includes a coupling portion shown as a connector 264 along bottom surface 214 instead of a rim (e.g., rim 24 as best seen in FIG. 2). Connector 264 can vary. In some embodiments, connector 264 includes an adhesive disk or ring 266 having a peel-away covering 268 disposed over it. Adhesive disk 266 may include a pressure-sensitive or other type of adhesive layer that is attached to bottom surface 214. Adhesive disk 266 may or may not include a foam base or liner that is used to connect adhesive disk 266 to bottom surface 214. To use connector 264, a user may simply peel away covering 268 in order to expose adhesive disk 266 and then attach adapter body 210 to a sound device by pressing the two objects together with his or her fingers. In alternative embodiments, connector 264 may simply include a foam base having an adhesive surface or another suitable type of attachment means for attaching adapter body 210 to a sound device.

The remaining structures shown in FIG. 11 may be substantially similar to the analogous structures depicted in the other figures. For example, adapter body 210 may include projection 216 that is similarly configured to any of the projections described herein. Coupling member 244 may be attached to projection 216 and may be adapted to attach adapter body 210 to sleeve 28. As described above, coupling member 244 may be a distinct structural component that is attachable to sleeve 28 and projection 216, or it may be integral with projection 216 and/or sleeve 28.

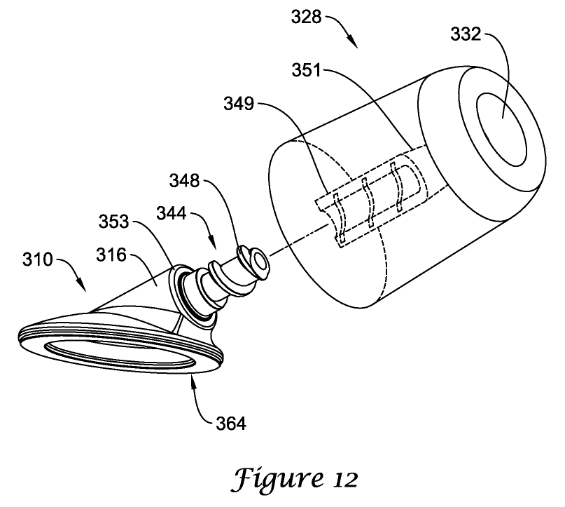

FIG. 12 depicts another example adapter body 310, coupling member 344, and sleeve 328. Adapter body 310 is substantially similar to adapter body 210 and may include projection 316 and connector 364. Coupling member 344 is similar to other coupling members described herein except that second end region 348 includes a thread. As described above, coupling member 344 may be a distinct structural component that is attachable to sleeve 328 or it may be integral with projection 316 and/or sleeve 328.

Threaded second end region 348 of coupling member 344 is configured to threadably engage sleeve 328. In some embodiments, sleeve 328 includes a threaded nut portion 349 (shown in phantom) disposed in or adjacent the hole 332 of sleeve 328. Accordingly, threaded second end region 348 can mate with threaded nut portion 349 so as to secure coupling member 344 (and, thus, adapter body 310) with sleeve 328. When coupled, sleeve 328 may abut a flange portion 353 of projection 316. Flange portion 353 provides a stopping point that will stop sleeve 328 from being screwed onto adapter body 310 any further than desired. Within sleeve 328 and extending from threaded nut portion 349 may be a flexible tapered portion 351. Flexible portion 351 allows sleeve 328 to be flexible so that it can conform to the shape of a user's ear canal while connected to adapter body 310. Moreover, this flexibility allows sleeve 328 to fit comfortably yet securely in the user's ear. Further suitable sleeves and coupling members that are similar in structure and function to sleeve 328 and coupling member 344 can be found in U.S. Pat. No. 5,002,151, the disclosure of which is incorporated herein by reference.

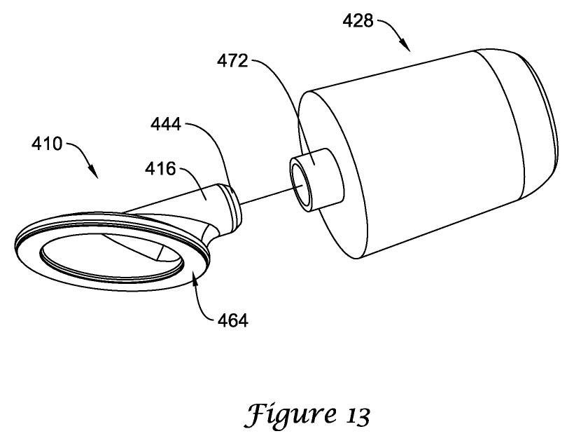

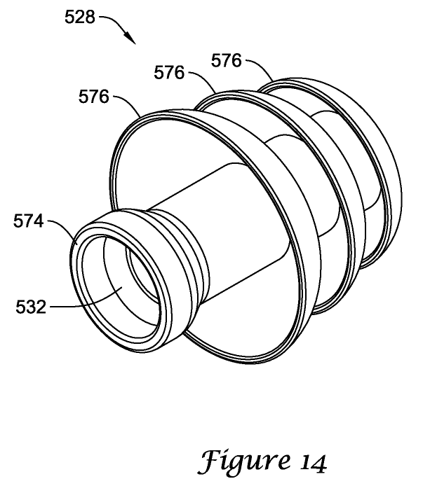

FIG. 13 depicts another example adapter body 410, coupling member 444, and sleeve 428. Adapter body 410 is substantially similar to adapter body 310 and may include projection 416 and connector 464+Coupling member 444 may comprise a sloped ridge configured for an interference fit with sleeve 428, for example, at a connector region 472 disposed on sleeve 428. According to this embodiment, a user may attach sleeve 428 to adapter body 410 by simply pushing sleeve 428 into contact with coupling member 444 in a manner that engages these structures and holds them together due to the interference-type connection. Aside from connector region 472, sleeve 428 may be similar to any of the other sleeves described herein. As described above, coupling member 444 may be a distinct structural component that is attachable to sleeve 428 or it may be integral with projection 416 and/or sleeve 428.

FIG. 14 is a perspective view of another example sleeve 528 for use with any of the adapter bodies and coupling members disclosed herein. Sleeve 528 may include an axial lumen or sound conduit 532, which is similar to lumen 32 described above in relation to sleeve 28. Sleeve 528 may also include a mouth region 574 for connecting sleeve 528 to an adapter body or coupling member. For example, sleeve 528 may be attached to a coupling member or adapter body by disposing mouth 574 about the relevant structure. In addition, sleeve 528 may include one or more flaps or flanges 576. In some embodiments, sleeve 528 may include one, two, three, four, five, or more flanges. Flanges 576 may be configured so that they can bend inward or fold over when disposed in the ear canal of a user. For example, one flange 576 may fold over an adjacent flange 576. This feature may provide greater comfort for the user as well as the other sound-isolating and other desirable features described above. Sleeve 528 may be made from any suitable material. For example, sleeve 528 may be made from silicone rubber, elastomeric polymer, or any of the materials disclosed herein.

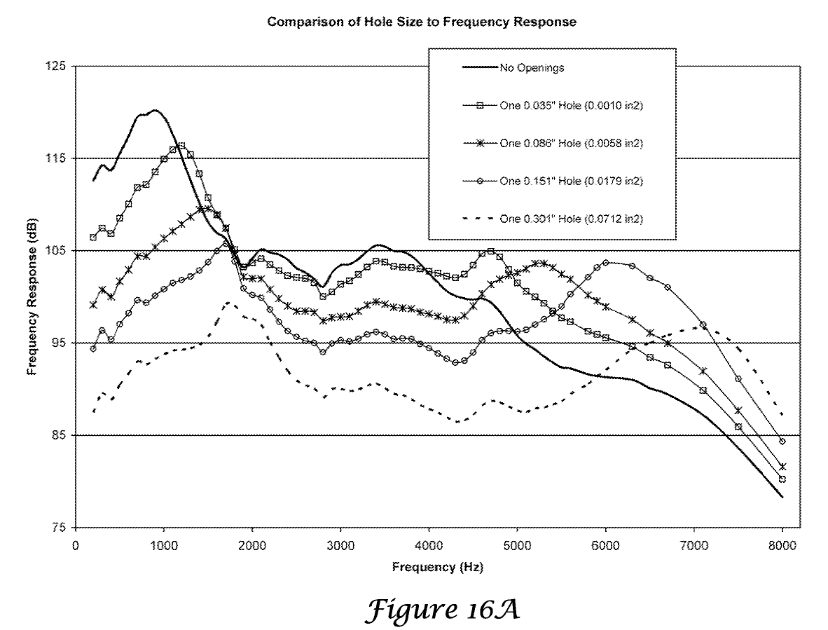

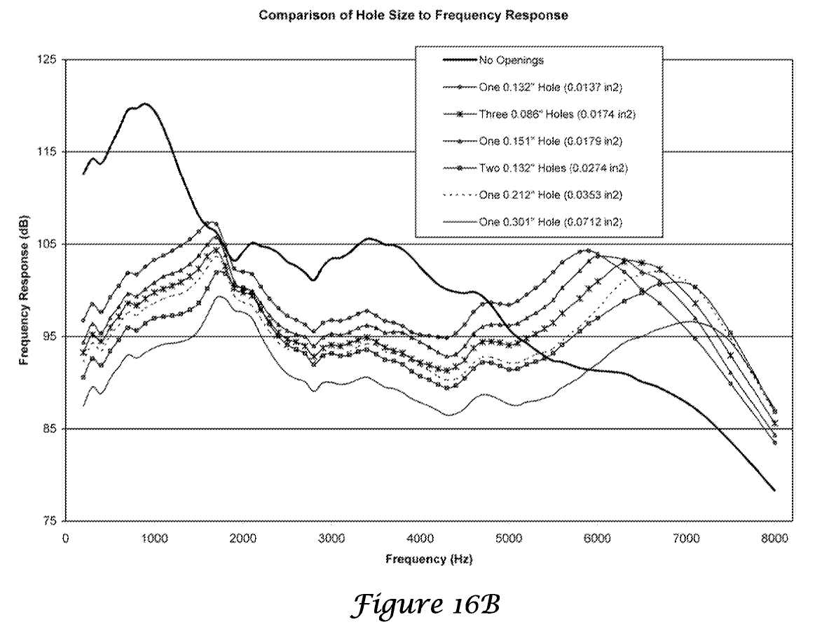

As mentioned above, the one or more unobstructed orifices 70 provided in the adapter body 10 have been found to modify frequency response of the adapter 10 for some users. An illustrative depiction of the frequency response evidenced by the area of various sizes and/or number of orifices 70 is illustrated in FIGS. 16A and 16B.

Audible frequencies can be divided into low-range frequencies, mid-range frequencies, and high-range frequencies. Although there is no standard for the band of frequencies that fall within each category, as discussed herein, frequencies less than about 1800 Hertz (Hz) are considered low-range frequencies, frequencies between about 1800 Hz to about 4500 Hz are considered mid-range frequencies, and frequencies greater than about 4500 Hz are considered high-range frequencies. These frequency ranges may be useful when evaluating the data represented in FIGS. 16A and 16B.

FIG. 16A depicts acquired data demonstrating the effect that the size of the orifice 70 of the adapter body 10 has on frequency response (decibels, dB) throughout a range of frequencies. As shown in FIG. 16A, an adapter 10 without any orifices 70 has a notably high frequency response throughout the low-range frequencies and the frequency response trails off through the high-range frequencies. As shown in FIG. 16A the frequency response of an adapter 10 having an unobstructed orifice 70 is generally reduced throughout the low-range frequencies and the mid-range frequencies compared to an adapter 10 without an orifice 70. Furthermore, the frequency response at high-range frequencies of an adapter 10 having an unobstructed orifice 70 is modified, for example, as shown in FIG. 16A the frequency response at high-range frequencies may be extended out over a greater range of frequencies compared to an adapter 10 without an orifice 70. As shown in FIG. 16A, as the area of the orifice 70 (size of the opening) increases, the frequency response generally decreases throughout the low-range frequencies (i.e., frequencies less than 1800 Hz) and the mid-range frequencies (i.e., frequencies between 1800 Hz to 4500 Hz), while the frequency response is modified at high frequencies. For example, the frequency response may be generally extended out to higher frequencies throughout the high-range frequencies (i.e., frequencies greater than 4500 Hz).

FIG. 16B depicts acquired data demonstrating the effect that the total area of the one or more orifices 70 of the adapter body 10 has on frequency response (decibels, dB) throughout a range of frequencies. As shown in FIG. 16B, the frequency response of an adapter 10 having three orifices 70 of 0.086 inch diameter each (total area of 0.0174 in²) is generally less than the frequency response of an adapter 10 having one orifice 70 of 0.151 inch diameter (total area of 0.0179 in²) at the same frequency throughout the low-range frequencies and mid-range frequencies, and is generally greater throughout the high-range frequencies. A similar result was acquired with an adapter 10 having two orifices 70 of 0.132 inch diameter each (total area of 0.0274 in²) compared with an adapter 10 having one orifice 70 of 0.212 inch diameter (total area of 0.0353 in²). Thus, from the acquired data it appears as though the frequency response of an adapter 10 with a plurality of orifices 70 having an equivalent total area as an adapter 10 with a single orifice 70 may produce a reduction of frequency response throughout the low-range and mid-range frequencies, and modify the frequency response of high-range frequencies. For example, in some embodiments the frequency response may be extended out to higher frequencies throughout the high-range frequencies.

FIG. 17A shows a cross section of the adapter 10 in association with an earbud 40 prior to being coupled to the earbud 40. The earbud 40 includes a housing 80 enclosing an electro-acoustic transducer 82 including a driver (e.g. speaker) 84. The driver 84 converts electrical energy delivered through wiring 86 into acoustical energy produced on the acoustical output side of driver 84. A speaker grille 42 including sound emanating through holes 43 may be positioned in front of the driver 84 on the acoustical output side of the driver 84 to protect the internal components of the earbud 40. Acoustical energy (e.g., sound waves) emitted from the driver 84 may pass through the sound emanating through holes 743.

The adapter 10 includes wall 21 having a first, outer surface 13 and a second, inner surface 15. In some embodiments the wall 21 may be a dome-shaped wall, such as a hemispherical wall or a semispherical wall having a concave inner surface 15 and a convex outer surface 13. A projection 16 extends from the wall 21 of the adapter 10 at an angle θ, which may be an acute angle measured between the longitudinal axis of the projection and the plane across the open side of the adapter 10 which the rim 24 lies. The projection 16 includes a sound conduit 22 extending from the interior cavity 31 of the adapter 10. A sleeve 28 may be attached to the projection 16. For example, in some embodiments the sleeve 28 may be adhesively bonded to the projection 16. As shown in FIG. 17A, the projection 16 extends into the lumen 32 of the sleeve 28, but in some embodiments may not extend to the tip 29 of the sleeve 28, such that the end 17 of the projection 16 is located within the confines of the sleeve 28. The adapter 10 includes one or more unobstructed orifices 70 extending through the wall 21 of the adapter 10 from the first surface 13 to the second surface 15.

As shown in FIG. 17B, the adapter 10 may be removably coupled to the housing 80 of the earbud 40. For example, as shown in FIG. 17B, the rim 24 of the adapter 10 may extend over a portion of the housing 80, forming an interference fit, such as a frictional and/or interlocking fit, between the adapter 10 and the housing 80 of the earbud 40.

When the adapter 10 is coupled to the earbud 40, as shown in FIG. 17B, the speaker grille 42 of the earbud 40, or a portion thereof, is spaced-away from the inner surface 15 of the adapter 10, thereby forming a sound transmitting cavity 90 between the inner surface 15 and the grille 42. Thus, sound emanating from through holes 43 of the speaker grille 42 may pass into the sound transmitting cavity 90. In some embodiments, the sound transmitting cavity 90 may be a crescent-shaped gap having a convex side defined by the inner concave surface 15 of the adapter 10 and/or a concave side defined by the convex surface of the grille 42. In some embodiments the sound transmitting cavity 90 may be about 0.02 inches to about 0.2 inches across at its widest point. In other words, in some embodiments the grille 42 may be spaced away from the inner surface 15 by a distance of about 0.02 inches to about 0.2 inches at the widest point, forming a sound transmitting cavity 90 therebetween. In some embodiments, the spacing between the grille 42 and the inner surface 15, and thus the width of the sound transmitting cavity 90, may be about 0.1 inches.

When the adapter 10 is coupled to the earbud 40, at least a portion of the perimeter of the one or more orifices 70 may be spaced away from the grille 42. In such an arrangement both the orifice 70 and the sound conduit 22 are in sound communication with the sound transmitting cavity 90 on the downstream side (i.e. the sound emanating side) of the grille 42. In other words, both the orifice 70 and the opening of the sound conduit 22 open into the sound transmitting cavity 90. In some embodiments the entire perimeter of the one or more orifices 70 may be spaced from the grille 42 of the earbud 40.

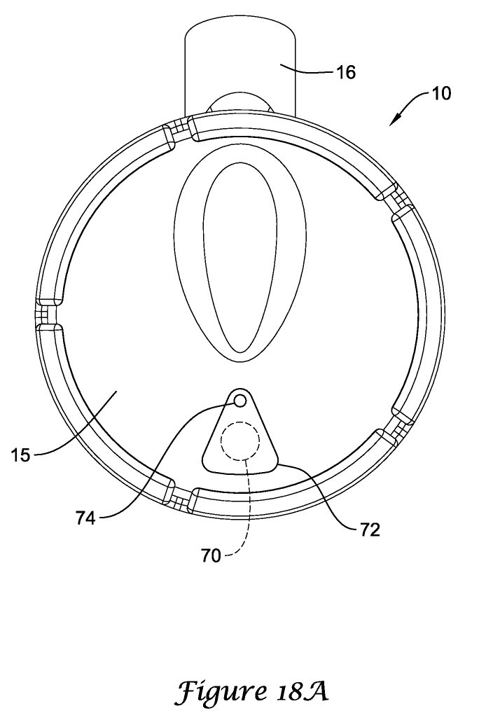

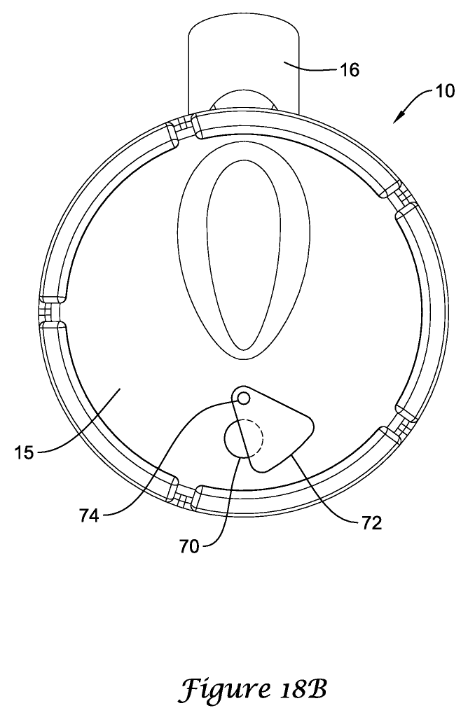

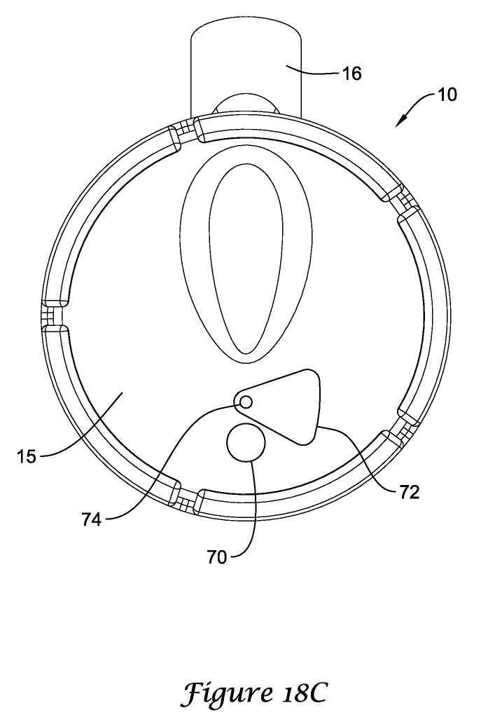

FIGS. 18A-18C illustrate an adapter 10 including a means for regulating the area of the at least one orifice 70 by a user. As shown in FIGS. 18A-18C, the adapter may include a moveable member 72, shown positioned on the inner surface 15 of the adapter 10, which may selectively partially and/or entirely cover the one or more orifices 70. In FIG. 18A the moveable member 72 is positioned such that the orifice 70 is completely covered by the moveable member 72. At this position, the characteristics of the adapter 10 may resemble those of an adapter without an orifice 70. The moveable member 72 may be selectively moved by a user (e.g., rotated, slid, turned, flipped, etc.) to vary the area of the orifice 70 which is unobstructed. For example, the moveable member 72 may be rotated about the pivot point 74, illustrated as a pin extending from the inner surface 15 of the adapter body 10. As shown in FIG. 18B, the moveable member 72 may be moved to an intermediate position such that a portion of the orifice 70 is unobstructed by the moveable member 72. As desired by the user, the moveable member 72 may be moved to any desired position between the completely obstructed position shown in FIG. 18A to the completely unobstructed position shown in FIG. 18C, In such an embodiment, a user may adjust the unobstructed area of the orifice 70 to alter the frequency response of the adapter 10 to his or her desired level. Thus, an adapter 10 having such adjustment means may be individualized between users to a desired level.

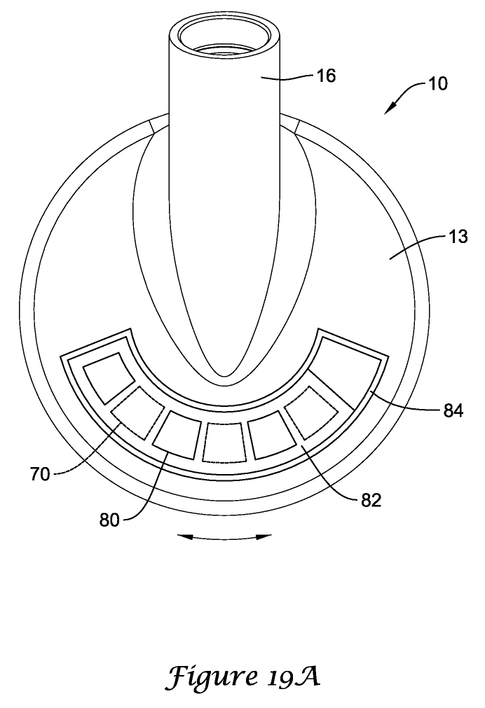

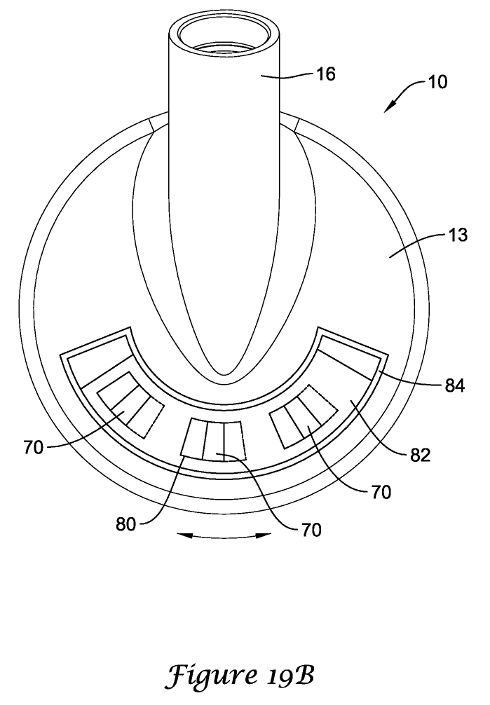

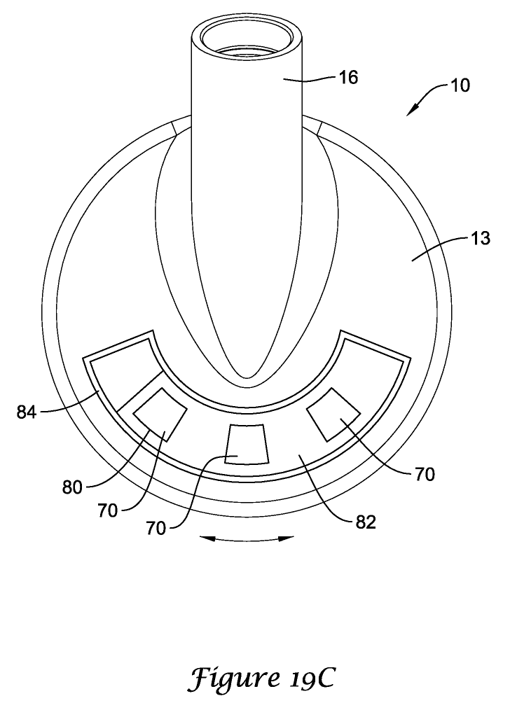

FIGS. 19A-19C show an alternate means for regulating the area of the at least one orifice 70 by a user. The adapter 10 of FIGS. 19A-19C includes a moveable member 82, shown positioned on the outer surface 13 of the adapter 10, which may selectively partially and/or entirely cover the one or more orifices 70. The moveable member 82 may include one or more openings 80 extending through the moveable member 82. In FIG. 19A the moveable member 82 is positioned such that the one or more orifices 70 is completely covered by the moveable member 82. In other words, the one or more openings 80 of the moveable member 82 are misaligned or shifted from the orifices 70. At this position, the characteristics of the adapter 10 may resemble those of an adapter without an orifice 70. The moveable member 82 may be selectively moved by a user (e.g., rotated, slid, turned, flipped, etc.) to vary the area of the orifice 70 which is unobstructed. For example, the moveable member 82 may be slid within guide channels 84 to a second position. As shown in FIG. 19B, the moveable member 82 may be moved to an intermediate position such that a portion of the one or more orifices 70 are unobstructed by the moveable member 82. In other words, the moveable member 82 may be moved such that the one or more openings 80 are partially aligned with the one or more orifices 70. As desired by the user, the moveable member 82 may be moved to any desired position between the completely obstructed position shown in FIG. 19A to the completely unobstructed position shown in FIG. 19C. In the completely unobstructed position shown in FIG. 19C, the one or more openings 80 may be aligned with the one or more orifices 70 such that no portion of the orifices 70 is obstructed by the moveable member 82. In such an embodiment, a user may adjust the unobstructed area of the one or more orifices 70 to alter the frequency response of the adapter 10 to his or her desired level. Thus, an adapter 10 having such adjustment means may be individualized between users to a desired level.

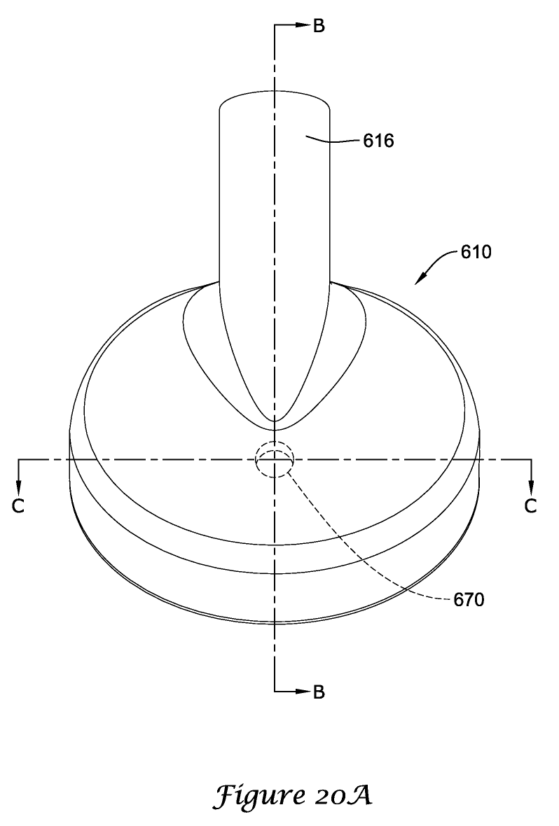

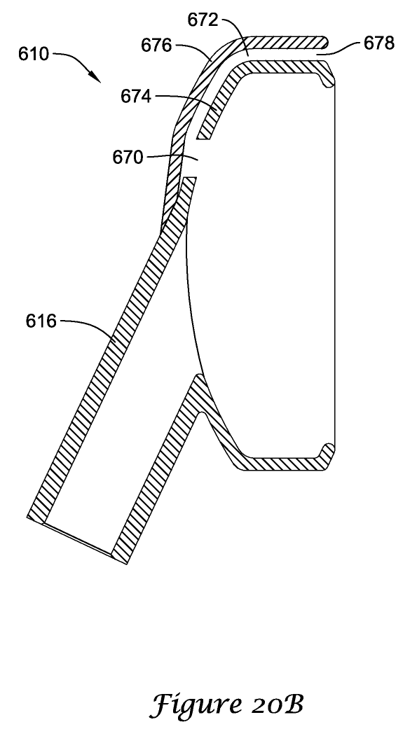

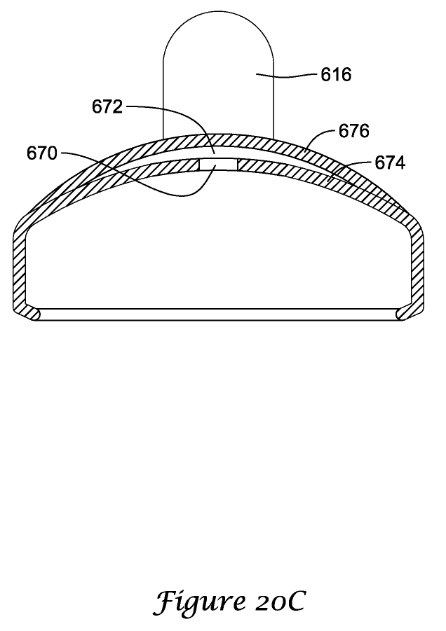

An alternative adapter 610 is illustrated in FIGS. 20A-20C. Apart from the components of the adapter 610 expressly described herein, the adapter 610 may be substantially similar to the adapter 10. Thus, in the interest of brevity, analogous structures and similar components of the adapter 610 with that of the adapter 10 will not be repeated. For example, as shown in FIG. 20A the adapter 610 may include a projection 616 extending from the top surface 613 of the adapter 610 for transmitted sound to the ear canal of a user.

The adapter 610 may include one or more unobstructed orifices 670. The one or more unobstructed orifices 670 may be more easily shown from FIGS. 20B and 20C, which are perpendicular cross sectional views taken through the orifice 670. As shown in FIGS. 20B and 20C, the orifice 670 may open into a passageway 672 formed between a first wall 674 (e.g., an inner wall) and a second wall 676 (e.g., an outer wall) of the adapter 610. Thus, the second wall 676 may shield the orifice 670 without obstructing the orifice 670. In such an embodiment, acoustical energy leaked through the one or more unobstructed orifices 670 may be redirected through the passageway 672 and out opening 678.

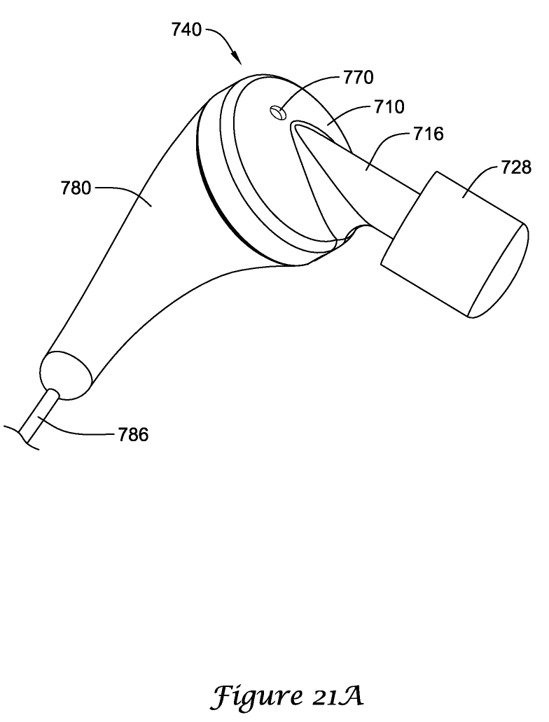

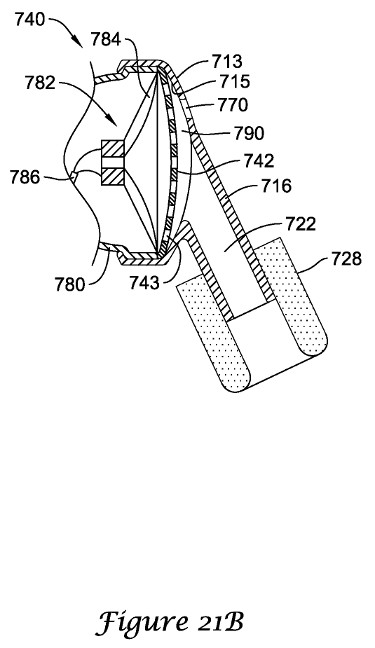

An earbud 740 including a cover 710 as integral component of the earbud 740 is illustrated in FIGS. 21A and 21B. The cover 710 includes a projection 716 extending from the cover 710. A sleeve 728 which is configured to be placed in the ear canal of a user may be coupled to the projection 716. The cover 710 includes one or more unobstructed orifices 770 formed in the cover 710 for allowing acoustical energy leakage from the device. As shown in FIG. 21B, the one or more unobstructed orifices 770 extend between the outer surface 713 and the inner surface 715 of the cover 710.

The earbud 740 includes a housing 780 enclosing an electro-acoustic transducer 782 including a driver (e.g. speaker) 784. The driver 784 converts electrical energy delivered through wiring 786 into acoustic energy produced on the acoustical output side of driver 784. A speaker grille 742 including sound emanating through holes 743 is positioned in front of the driver 784 on the acoustical output side of the driver 784 to protect internal components of the earbud 740. Acoustical energy (e.g., sound waves) emitted from the driver 784 may pass through the sound emanating through holes 743.

In some embodiments the cover 710 may be a dome-shaped cover, such as a hemispherical or semispherical cover having an inner concave surface 715 and an outer convex surface 713. During a manufacturing process, the cover 710 may be secured to the housing 780 by adhesive bonding, fasteners, mechanical interlocking, or the like. When the cover 710 is secured to the housing 780, a sound transmitting cavity 790 remains between the speaker grille 742 and the inner surface 715 of the cover 710. Thus, sound emanating from through holes 743 of the speaker grille 742 may pass into the sound transmitting cavity 790. In some embodiments, the sound transmitting cavity 790 may be a crescent-shaped gap having a convex side defined by the inner concave surface 715 of the cover 710 and/or a concave side defined by the convex surface of the grille 742. In some embodiments the sound transmitting cavity 790 may be about 0.02 inches to about 0.2 inches across at its widest point. In other words, in some embodiments the grille 742 may be spaced away from the inner surface 715 by a distance of about 0.02 inches to about 0.2 inches at the widest point, forming a sound transmitting cavity 790 therebetween. In some embodiments, the spacing between the grille 742 and the inner surface 715, and thus the width of the sound transmitting cavity 790, may be about 0.1 inches.

Thus, the one or more orifices 770 may be spaced away from the grille 742. For example, at least a portion of the perimeter of the one or more orifices 770 may be spaced away from the grille 742. In such an arrangement both the orifice 770 and the sound conduit 722 are in sound communication with the sound transmitting cavity 790 on the downstream side (i.e., the sound emanating side) of the grille 742. In other words, both the orifice 770 and the opening of the sound conduit 722 open into the sound transmitting cavity 790. In some embodiments the entire perimeter of the one or more orifices 770 may be spaced from the grille 742 of the earbud 740.

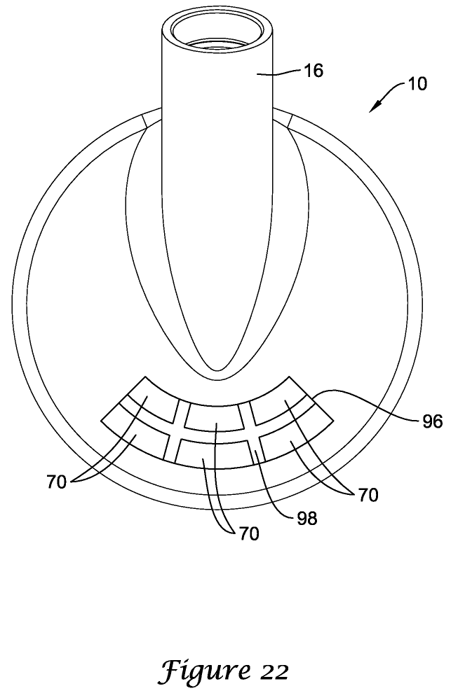

FIG. 22 illustrates yet another embodiment of the adapter 10. As shown in FIG. 22, the adapter 10 may include an aperture 96 extending through the adapter 10. A lattice, mesh or screen 98 may extend across the aperture 96, dividing the aperture 96 into multiple unobstructed orifices 70. The orifices 70 may allow the free passage of sound energy to escape from the adapter 10, while the lattice, mesh or screen 98 may prevent entry of foreign material through the aperture 96. Thus, in some embodiments, the one or more unobstructed orifices 70 may be that portion of one or more larger openings or apertures which remain unobstructed during use.

It should be understood that this disclosure is, in many respects, only illustrative. Changes may be made in details, particularly in matters of shape, size, and arrangement of steps without exceeding the scope of the invention. The invention's scope is, of course, defined in the language in which the appended claims are expressed.

What is claimed is:

1. An adapter for removably coupling to an earbud, the adapter comprising:
an adapter body including a top portion having a first surface and an opposing second surface;
a projection extending from the first surface of the top portion of the adapter body, the projection including a sound conduit extending from an opening in the second surface of the adapter body;
a sleeve disposed over at least a portion of the projection, the sleeve being configured to be positioned at least in part into the ear canal of a user; and
at least one unobstructed orifice extending between the first surface and the second surface of the adapter body, the at least one unobstructed orifice or sum of the orifices having a total area of at least about 0.0003 in².

2. The adapter of claim 1, wherein the earbud includes a sound outlet surface having a plurality of sound emanating through holes, and in use the top portion of the adapter covers at least a portion of the sound emanating through holes and at least a portion of the second surface faces the covered sound emanating through holes.

3. The adapter of claim 2, wherein the sound outlet surface comprises a speaker grille.

4. The adapter of claim 2, wherein in use at least a portion of the second surface of the top portion is covering the sound emanating through holes and is spaced a distance from the sound emanating through holes to form a sound transmitting cavity therebetween.

5. The adapter of claim 4, wherein the sound conduit opening in the second surface and at least one unobstructed orifice between the first and second surfaces open into the sound transmitting cavity.

6. The adapter of claim 1, wherein the earbud includes a speaker grille, and in use at least a portion of the second surface of the top portion of the adapter covers at least a portion of the speaker grille and is spaced a distance from the speaker grille to form a sound transmitting cavity therebetween.

7. The adapter of claim 6, wherein the sound conduit opening in the second surface and at least one unobstructed orifice between the first and second surfaces open into the sound transmitting cavity.

8. The adapter of claim 1, wherein the adapter body includes a means for retaining the adapter to an earbud.

9. The adapter of claim 8, wherein the means for retaining the adapter to an earbud includes creating an interference fit between the adapter body and the earbud.

10. The adapter of claim 1, wherein the projection extends at an acute angle from the first surface of the top portion.

11. The adapter of claim 1, wherein the sum of the at least one unobstructed orifice has a total area of at least 0.001 in².

12. The adapter of claim 1, wherein the sum of the at least one unobstructed orifice has a total area of at least 0.0025 in².

13. The adapter of claim 1, wherein the sum of the at least one unobstructed orifice has a total area of at least 0.01 in².

14. The adapter of claim 1, wherein the sum of the at least one unobstructed orifice has a total area of at least 0.02 in² .

15. The adapter of claim 1, wherein the sum of the at least one unobstructed orifice has a total area of at least 0.025 in².

16. The adapter of claim 1, wherein the at least one unobstructed orifice is located on a sound output side of a driver of an earbud when the adapter is coupled to an earbud.

17. The adapter of claim 1, wherein the at least one unobstructed orifice allows leakage of acoustic energy output from the adapter.

18. The adapter of claim 1, wherein the at least one unobstructed orifice reduces the level of low frequency acoustic energy traveling through the sound conduit of the adapter.

19. The adapter of claim 1, wherein the at least one unobstructed orifice includes two or more through holes.

20. The adapter of claim 1, further comprising a means for regulating the area of the at least one unobstructed orifice by a user.

21. An adapter for coupling to a housing of an earbud, the adapter comprising:
a body including a wall having a first side and a second side, the second side facing a speaker grille of an earbud when the adapter is coupled to an earbud, the body further including a coupling portion configured for removably coupling to the housing of an earbud;
a projection extending from the wall of the body, the projection having a sound conduit extending from a first opening in the second side of the wall to a second opening in the projection;
a sleeve disposed over at least a portion of the projection, the sleeve configured to be positioned into at least a portion of an ear canal of a user; and
at least one unobstructed orifice extending through the wall of the body from the first side to the second side, the unobstructed orifice positioned so as to allow sound energy to escape from the adapter.

22. The adapter of claim 21, wherein the at least one unobstructed orifice reduces the level of low frequency acoustic energy traveling through the sound conduit of the adapter.

23. The adapter of claim 21, wherein there is a sound transmitting cavity between the second surface and the speaker grille of the earbud when the adapter is coupled to the earbud.

24. The adapter of claim 23, wherein the second surface is spaced from the speaker grille by a distance of at least about 0.02 inches.

25. The adapter of claim 23, wherein the second surface is spaced from the speaker grille by a distance of at least about 0.01 inches.

26. The adapter of claim 23, wherein the second surface is spaced from the speaker grille by a distance between about 0.02 inches to about 0.2 inches.

27. The adapter of claim 23, wherein the first opening of the sound conduit and at least one unobstructed orifice open into the sound transmitting cavity.

28. The adapter of claim 21, wherein the at least one unobstructed orifice has an area of between about 0.0003 in² to about 0.07 in².

29. The adapter of claim 21, wherein the at least one unobstructed orifice has an area of between about 0.0005 in² to about 0.005 in².

30. The adapter of claim 21, wherein the at least one unobstructed orifice has an area of between about 0.005 in² to about 0.02 in².

31. The adapter of claim 21, further comprising a means for regulating the area of the at least one unobstructed orifice by a user.

32. An adapter for removably coupling to an earbud, the adapter comprising:
an adapter body including a top portion having a first surface and an opposing bottom second surface;
a coupling portion for removably coupling the adapter body to an earbud;
a projection extending from the top portion of the adapter body, the projection including a sound conduit extending from an opening in the second surface of the top portion of the adapter body;
a sleeve disposed over at least a portion of the projection, the sleeve being configured to be positioned into at least a portion of the ear canal of a user; and
a means for allowing leakage of acoustic energy output from the adapter.

33. The adapter of claim 32, wherein the means for allowing leakage of acoustic energy output from the adapter is located on a sound output side of a driver of the earbud.

34. The adapter of claim 32, wherein the means for allowing leakage of acoustic energy output from the adapter modifies the level of acoustic energy delivered to the ear canal of a user.

35. The adapter of claim 32, wherein the means for allowing leakage of acoustic energy output from the adapter is an unobstructed orifice in the adapter body.

36. An adapter for removably coupling to an earbud, the adapter comprising:
an adapter body including a top portion having a first surface and a bottom portion having a second surface;
a means for coupling the adapter body to an earbud;
a projection extending from the top portion of the adapter body, the projection including a sound conduit extending from an opening in the second surface of the adapter body;
a sleeve disposed over at least a portion of the projection, the sleeve being configured to be positioned into at least a portion of the ear canal of a user; and
a means for modifying the level of acoustic energy delivered to the ear canal of a user through the sound conduit of the adapter.

37. The adapter of claim 36, wherein the means for modifying the level of acoustic energy delivered to the ear canal of a user through the sound conduit of the adapter is an unobstructed orifice in the adapter body.

38. The adapter of claim 37, wherein the unobstructed orifice in the adapter body allows leakage of acoustic energy output from the adapter.

39. An earbud-type sound device, comprising:
a housing;
a driver located within the housing, the driver providing acoustical energy from an acoustical output side of the driver;
a projection extending from the housing on the acoustical output side of the driver, the projection including a sound conduit for delivering sound to an ear canal of a user;
a sleeve disposed over at least a portion of the projection, the sleeve being configured to be positioned into at least a portion of the ear canal of a user; and
an unobstructed orifice in the housing on the acoustical output side of the driver.

40. The sound device of claim 39, wherein the unobstructed orifice reduces the level of low frequency acoustic energy traveling through the sound lumen of the sound device.

41. The sound device of claim 39, wherein the unobstructed orifice allows leakage of acoustical energy from the sound device.

42. An earbud-type sound device, comprising:
a housing;
a driver located within the housing, the driver providing acoustical energy from an acoustical output side of the driver;
a grille positioned in front of the driver on the acoustical output side of the driver;
a dome-shaped cover positioned in front of the grille, the dome-shaped cover having an inner concave surface spaced from the grille, thereby defining a sound transmitting cavity between the inner surface of the cover and the grille;
a projection extending from the cover, the projection including a sound conduit for delivering sound to an ear canal of a user; and
a sleeve disposed over at least a portion of the projection, the sleeve being configured to be positioned into at least a portion of the ear canal of a user.

43. The earbud-type sound device of claim 42, further comprising an unobstructed orifice in the cover on the acoustical output side of the driver,

44. The earphone of claim 43, wherein the unobstructed orifice has a perimeter, wherein at least a portion of the perimeter of the unobstructed orifice is spaced from the grille.

45. The earphone of claim 42, wherein the inner concave surface is spaced from the grille by a distance of at least about 0.02 inches.

46. The earphone of claim 42, wherein the inner concave surface is spaced from the grille by a distance of at least about 0.01 inches.

47. The earphone of claim 42, wherein the inner concave surface is spaced from the grille by a distance of between about 0.02 inches to about 0.2 inches.
